(19) United States
(12) Patent Application Publication
(10) Pub. No.: US 2003/0206789 A1
(43) Pub. Date: Nov. 6, 2003

(54) Automatic warehouse

(75) Inventors: Akito Tai, Kagamigahara-shi (JP); Hideji Sakata, Inuyama-shi (JP)

Correspondence Address: ARMSTRONG,WESTERMAN & HATTORI, LLP, 1725 K STREET, NW, SUITE 1000, WASHINGTON, DC, 20006, US

(73) Assignee: MURATA KIKAI KABUSHIKI KAISHA, Kyoto-shi (JP)

(21) Appl. No.: 10/405,493

(22) Filed: Apr. 3, 2003

(30) Foreign Application Priority Data
May 4, 2002 (JP) 2002-104309

(51) Int. Cl. B65G 1/00

(52) U.S. Cl. 414/275

(57) ABSTRACT

The present invention provides an automatic warehouse that enables an operator to work in an area located above his or her height as required. An automatic warehouse 1 comprises a pair of racks 3, 3 each provided with a large number of shelves 2 arranged in a vertical and lateral directions, and a transfer device 4 that moves between the pair of racks 3, 3. Work plates 7 can be arranged between the pair of racks 3, 3. Each of the work plates 7 comprises support members 8, 18 and 28 that bridge across the racks 3, 3 and plate materials 9 that can be freely attached to and removed from the support members 8, 18 and 28. The support members 8, 19 can be attached to and removed from corresponding body materials (struts 11, connection materials 12, or masts 13) constituting a frame of the automatic warehouse 1. The constituent members (plate materials 9 and support members 8, 18) of the work plate 7 can be housed inside the automatic warehouse 1 and outside a route for the transfer device 4.

### FIELD OF THE INVENTION

The present invention relates to an automatic warehouse comprising racks (housing section) each provided with a large number of shelves and a transfer device that moves along the racks, as well as arrangements for installing and housing work plates which arrangements allow maintenance to be carried out easily and appropriately in the automatic warehouse.

### BACKGROUND OF THE INVENTION

An automatic warehouse has been known which comprises racks (housing section) each provided with a large number of shelves and a transfer device that move along the racks. Articles are housed on the shelves. A description will be given of a more specific example of configuration of such an automatic warehouse. Racks each provided with a large number of shelves are provided in the automatic warehouse. Masts are provided at the respective ends of one of the racks so as to extend in a vertical direction. Elevating and lowering tables are provided which elevate and lower along the respective masts. A large number of shelves are arranged in each rack in the vertical direction and in a lateral direction. On the other hand, the transfer device can be moved in the vertical direction using the pair of elevating and lowering tables. The transfer device can also be moved back and forth along a running rail. Consequently, the transfer device can be moved in the vertical and lateral directions of the rack. The lateral direction of the rack coincides with the front-to-back direction of the running rail.

In the automatic warehouse, an article that is not placed in the correct position must have its position adjusted by an operator. In this case, the automatic warehouse configured as previously described disadvantageously prevents the operator from adjusting the position of an article located above the operator's height. It is thus an object of the present invention to provide an automatic warehouse that enables the operator to work in an area located above his or her height.

### SUMMARY OF THE INVENTION

The problems to be solved by the present invention have been described above. A description will be given below of means for solving the problems.

That is, according to claim 1, there is provided an automatic warehouse comprising a housing section provided with a large number of shelves arranged at least in a vertical direction and a transfer device that moves along the housing section, wherein work plates are provided to block a route for the transfer device so as to form levels.

According to claim 2, each of the work plates comprises support members and plate materials that can be freely attached to and removed from the support members, and brackets are provided on corresponding body materials comprising a frame of the automatic warehouse so that the support members can be freely attached to and removed from the corresponding brackets.

According to claim 3, the constituent members of the work plate is provided inside the automatic warehouse and outside the route for the transfer device.

According to claim 4, the support member is provided on each of the support members to prevent the plate materials from rising from the support members.

According to claim 5, a sensor is provided to detect the presence of the work plate, and control means is provided to regulate operations of the transfer device while the sensor remains detecting the work plate.

### BRIEF DESCRIPTION OF THE DRAWINGS

FIG. 1 is a perspective view showing a configuration of an automatic warehouse 1.

FIG. 2 is a plan view showing the configuration of the automatic warehouse 1.

FIG. 3 is a perspective view showing a rack 3 opposite to masts inside the automatic warehouse 1.

FIG. 4 is a perspective view of interior of the automatic warehouse 1, showing that a support member 8 has been attached.

FIG. 5 is a perspective view of interior of the automatic warehouse 1, showing an arrangement for attaching a first-level work plate 7.

FIG. 6 is a perspective view of interior of the automatic warehouse 1, showing that the first-level work plate 7 and a ladder have been attached.

FIG. 7 is a perspective view of interior of the automatic warehouse 1, showing an arrangement for attaching a second-level work plate 7.

FIG. 8 is a perspective view of interior of the automatic warehouse 1, showing that the work plates 7, 7 have been completely installed.

FIG. 9 is a perspective view showing a layout of brackets 17 in the rack 3 opposite to the masts inside the automatic warehouse 1.

FIG. 10 is a perspective view showing a support member 18.

FIG. 11 is a perspective view showing an end of the support member 18 and a bracket 17.

FIG. 12 is a perspective view showing the support member 18 in its engaged position.

FIG. 13 is a perspective view showing a part of the work plate 7 which is near the support member 18.

FIG. 14 is a perspective view showing plate materials 9 and others housed in a first housing space.

FIG. 15 is a perspective view showing a locking member 20 and a bolt 27.

FIG. 16 is a perspective view showing a rack 3 with the masts inside the automatic warehouse 1, as viewed from below.

FIG. 17 is a perspective view showing a light emitting section 29a of a leave-behind preventing sensor 29.

FIG. 18 is a perspective view showing a light receiving section 29b of the leave-behind preventing sensor 29.

FIG. 19 is a block diagram showing a control mechanism for preventing the work plate from being left behind.

### DETAILED DESCRIPTION OF THE PREFERRED EMBODIMENTS

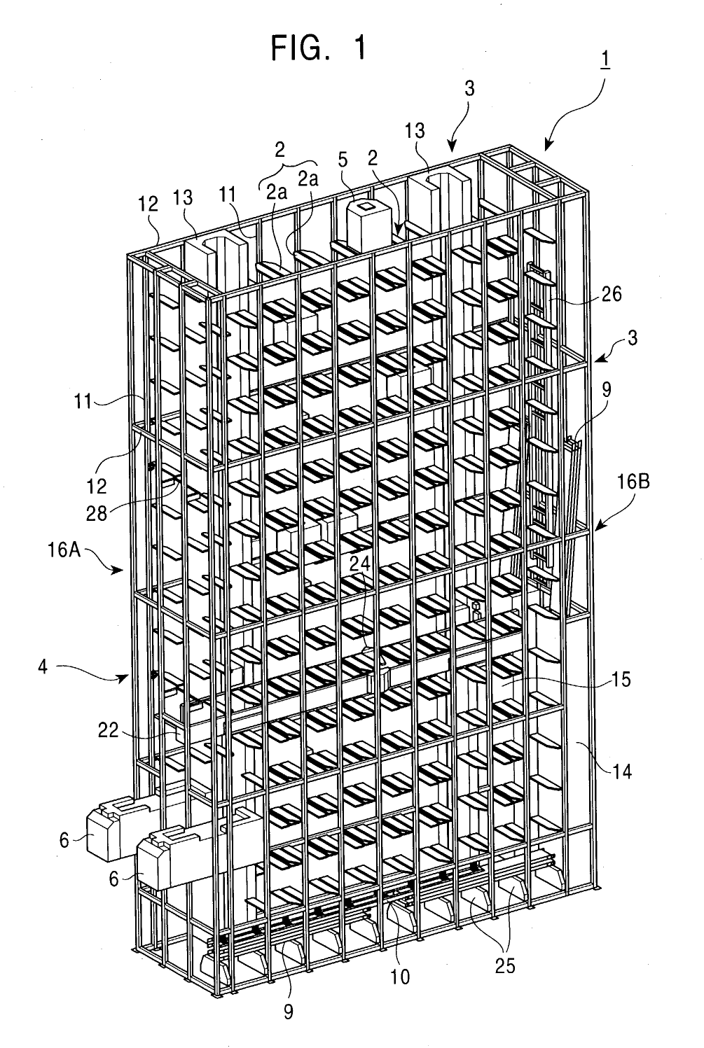

With reference to FIGS. 1, 2, 3, and 4, description will be given of a configuration of an automatic warehouse 1 as an embodiment of the present invention.

A pair of racks 3 each provided with a large number of shelves 2, 2, . . . is provided in the automatic warehouse 1 as shown in FIGS. 1, 2, 3 and 4. Further, as shown in FIGS. 1, 2 and 4, a transfer device 4 is provided which moves along the racks 3. In the present embodiment, the transfer device 4 moves between the pair of racks 3, 3. In the description below, for the convenience of description, the direction in which the racks 3, 3 are arranged parallel with each other is defined as a front-to-back direction. The direction in which each rack 3 is extended is defined as a lateral direction. The direction perpendicular to a floor surface is defined as a vertical direction.

A large number of shelves 2, 2, . . . are provided on the rack 3. A cassette 5 in which a large number of semiconductor wafers are housed is placed on each of the shelves 2. The rack 3 comprises struts 11 installed on a floor surface so as to extend in the vertical direction, each of the struts 11 being provided with a large number of shelf members 2a arranged on a side of the rack 13 in the vertical direction, and connection members 12 that connect the right and left struts 11 together at predetermined heights. The right and left shelf members 2a, 2a form the shelve 2. The front-to-back pair of racks 3 is provided, and these racks 3, 3 are connected together by the connection members 12. An outer wall of the automatic warehouse 1 is supported by the struts 11 and the connection members 12. However, for the convenience of description, the illustration of the outer wall is omitted.

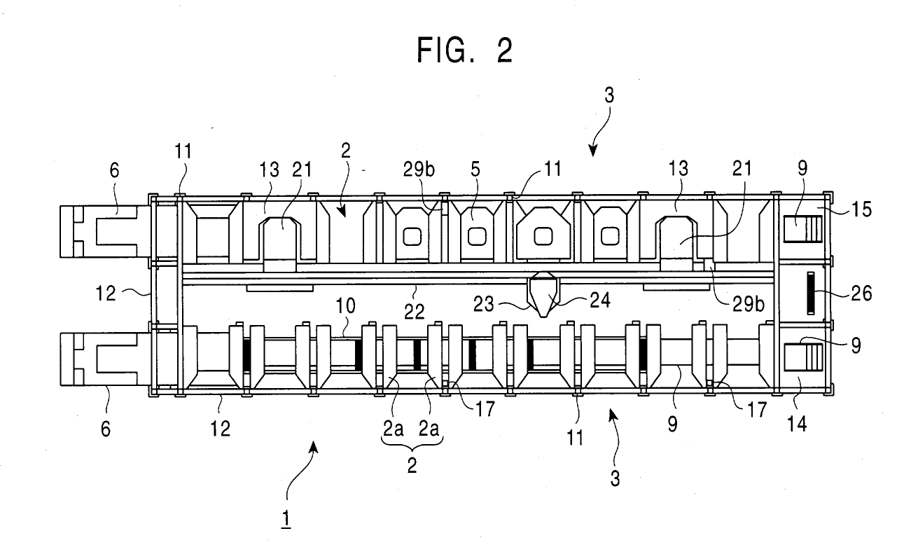

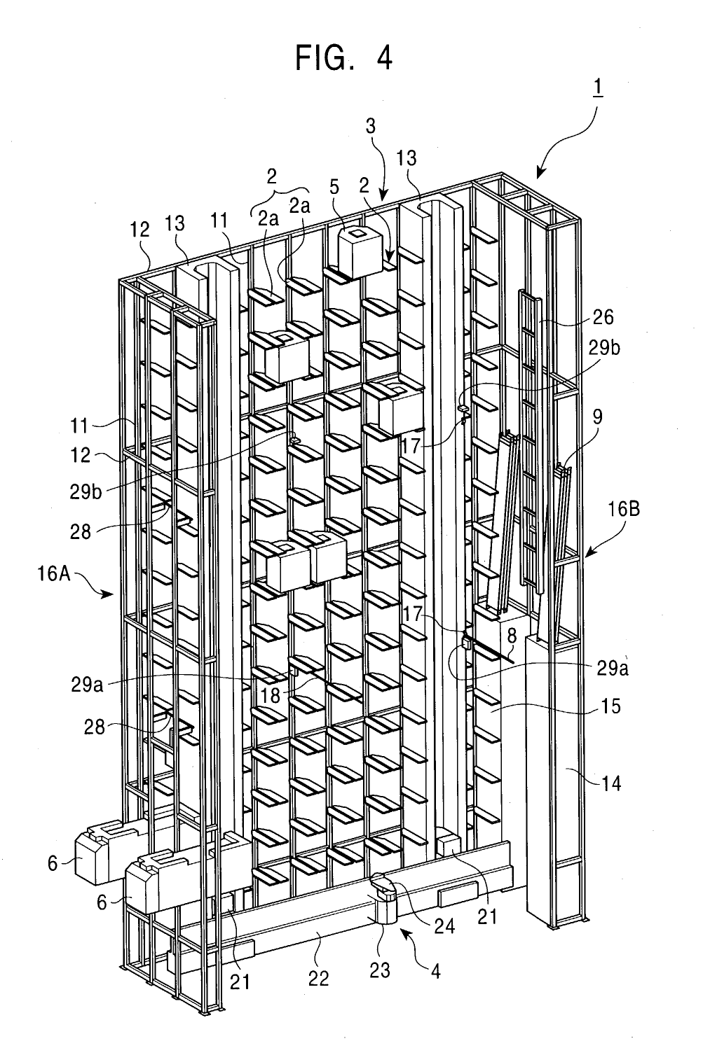

A configuration of the transfer device 4 will be described with reference to FIGS. 2 and 4.

As shown in FIGS. 2 and 4, masts 13, 13 are installed on one (the one located further from the reader in FIGS. 1 and 4) of the racks 3, 3 provided in the automatic warehouse 1. The masts 13, 13 are located on the right and left end sides, respectively, of this rack 3. The masts 13, 13 constitute a base for the transfer device 4. Elevating and lowering tables 21, 21 are provided in the corresponding masts 13, 13 so as to elevate and lower along the masts 13, 13. Each of the elevating and lowering tables 21 can be elevated and lowered along the corresponding mast 13 using a ball screw. The right and left elevating and lowering tables 21, 21 support a running rail 22. A moving member 23 is provided on the running rail 22 so as to run along the running rail 22. Transfer means 24 that is a scholar type robot hand is provided above the moving member 23 via a turn table (not shown in the drawings). The transfer means 24 is driven by the turn table to turn from one of the racks 3 to the other track 3. These arrangements constitute the transfer device 4 provided with the transfer means 24. Thus, the transfer means 24 can be moved to any position opposite to one of the shelves 2 on either of the racks 3 by being vertically moved by the elevating and lowering tables 21, 21, laterally moved by the moving member 23, or turned by the turn table. Then, the transfer means 24 can transfer the cassette 5 (load and unload the cassette 5 onto and from the shelf 2). The cassette 5 is unloaded from the shelf 2 by elevating the transfer means 24 from below the shelf 2 and scooping up the cassette 5. On the other hand, the cassette 5 is loaded onto the shelf 5 by lowering the transfer means 24 from above the shelf 2 and placing the cassette 5 on the shelf 2.

Conveyors 6, 6 are provided at the lower part of either lateral side of the automatic warehouse 1 to act as a storage part and a retrieval port of the automatic warehouse 1. The conveyors 6, 6 are located on the sides of the racks 3, 3, respectively. The automatic warehouse 1 carries out the transfer (storage and retrieval) of the cassette 5 between each external conveying device such as an automatic guided vehicle via the conveyors 6. Each of the conveyors 6 is provided with a placing section for guided vehicle on which the cassette 5 is transferred between the external conveying devices such as an automatic guided vehicles, a placing section for transfer device on which the cassette 5 is transferred between the transfer devices 4, and conveying means for transferring the cassette 5 between both placing sections. Then, for example, to store the cassette 5 into the automatic warehouse 1, the cassette 5 is transferred from the automatic guided vehicle to the placing section for guided vehicle by the transfer device mounted on the automatic guided vehicle. The transfer means then transfers the cassette 5 from the placing section for guided vehicle to the placing section for transfer device. The transfer device 4 then transfers the cassette 5 from the placing section for transfer device to the shelf 2 for storage.

Cases 14, 15 are provided at a lower end of the automatic warehouse 1 which is opposite the conveyors 6. A power supply device, control equipment, and the like are housed in the cases 14, 15.

Then, description will be given of arrangements for installing and housing work plates 7 for operations at high positions.

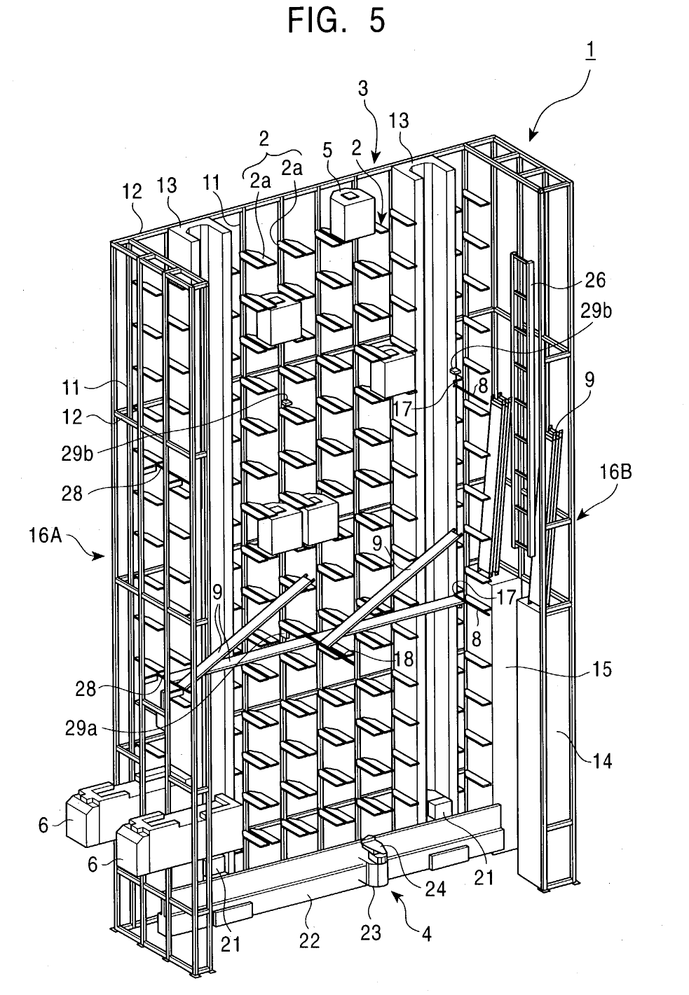

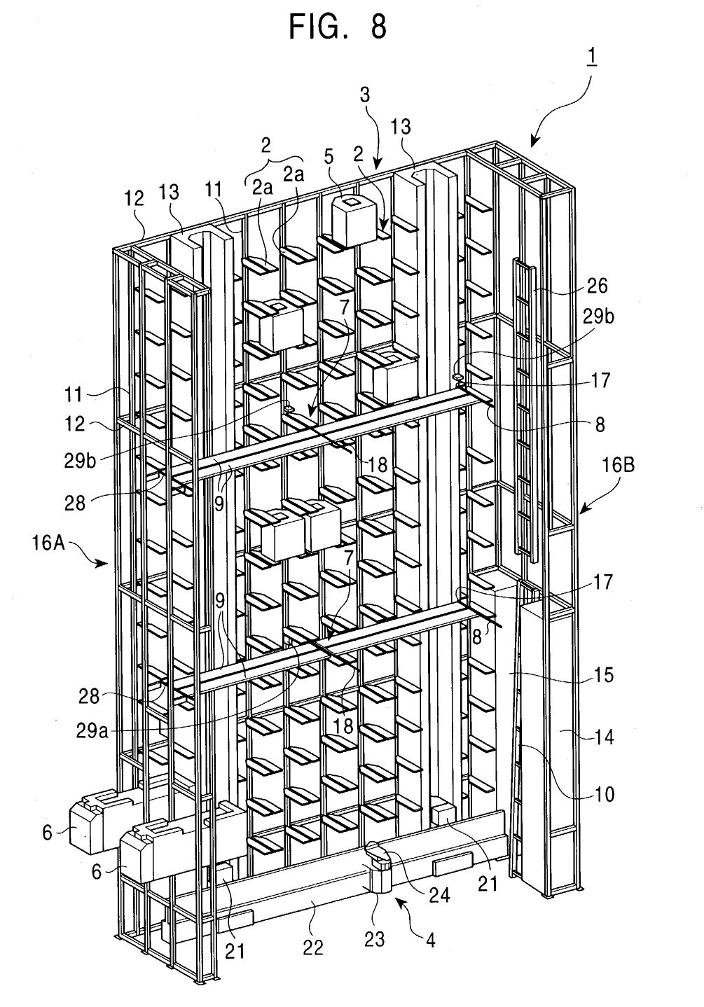

First, the work plates 7 will be described with reference to FIGS. 5, 6, 7 and 8.

The automatic warehouse 1 is configured so that the work plates 7 can be detachably arranged as shown in FIGS. 5, 6, 7 and 8. The work plates 7 are arranged between the pair of racks 3, 3. The gap between the racks 3, 3 forms a route for the transfer device 4. The running rail 22, provided in the transfer device 4, can be moved in the vertical direction between the racks 3, 3. Further, the transfer means 24, provided in the transfer device 4, can be moved along the running rail 22 in the lateral direction between the racks 3, 3. That is, the transfer means 24 of the transfer device 4 moves in the vertical and lateral directions between the racks 3, 3.

Thus, each of the work plates 7 is installed to block the gap between the racks 3, 3, which forms the route for the transfer device 4, so that an operator can work in an area located above his or her height as required. Further, the work plate 7 can be used not only for the maintenance of the automatic warehouse 1 but also for its construction to allow the automatic warehouse 1 to be easily assembled.

A configuration of each of the work plates 7 will be described. The work plate 7 comprises plate materials 9 on which the operator stands and support members 8, 18 and 28 that support the plate material 9. In the present embodiment, the three support members 8, 18 and 28 and four plate materials 9, 9, 9 and 9 constitute one work plate 7 as shown in FIGS. 5, 6, 7 and 8. In the present embodiment, the work plate 7 can constitute two stages, i.e. a first level and a second level.

The support members 8, 18 and 28 are arranged so as to bridge across the racks 3, 3 as shown in FIGS. 5, 6, 7 and 8. The support members 8, 18 are provided so as to be freely attached to and removed from corresponding body materials constituting a frame of the automatic warehouse 1. In the present embodiment, the support member 28 is fixed to the corresponding body material. As seen in a plan view, the support member 28 is located at a position closer to the conveyors 6, 6 than to the running rail 22 and outside the route for the transfer device 4. Accordingly, even when the support member 28 remains attached to the corresponding body material, it does not obstruct the driving of the transfer device 4 while the automatic warehouse 1 is in operation. Like the support members 8, 18, the support member 28 may be adapted to be freely attached to and removed from the body material. A description will be given later of an arrangement for freely attaching and removing the support members 8, 18 to and from the body material.

In the present embodiment, the body materials, on which the support members 8, 18 are detachably provided, are the struts 11 and the masts 13. The support member 8 is detachably installed on the mast 13 and on the strut 11 opposite to the mast 13 between the pair of opposite racks 3, 3. The support member 18 is detachably installed on the strut 11 and on another strut 11 opposite to the first strut 11 between the pair of opposite racks 3, 3. The distance between the mast 13 and the strut 11 is shorter than the distance between the struts 11, 11. Correspondingly, the support member 8 is formed to be shorter than the support member 18. The detachable support members 8, 18 may be installed only on the strut 11 rather than also being installed on the mast 13, or may be provided between the opposite connection members 12, 12.

The support member 28 is also provided to bridge across the pair of opposite racks 3, 3. However, it is fixed to the struts 11, 11, located at its side. The struts 11, 11, which support the support member 28, constitute a frame of a side wall 16A of the automatic warehouse 1 which is closer to the conveyors 6, 6.

Further, the plate materials 9 are detachably installed on the support members 8, 18 and 28. This detachable arrangement will also be described later.

Thus, the detachable work plate 7 can be provided using the simple arrangement composed of the support members 8, 18, which can be freely attached to and removed from the corresponding body materials, the support member 28, which is fixed to the corresponding body material, and the plate materials 9, which can be freely attached to and removed from the support members 8, 18 and 28.

With reference to FIGS. 1, 2, 3 and 4, description will be given of an arrangement for housing the constituent members of the work plate 7.

The constituent members of the work plate 7 include the support members 8, 18 and 28 and the plate materials 9. The constituent members of the work plate 7 other than the support member 28, which does not obstruct the route for the transfer device 4, i.e. the support members 8, 18 and the plate materials 9 can be housed inside the automatic warehouse 1 and outside the route for the transfer device 4. Two spaces are provided in the automatic warehouse 1 so as to house the constituent members of the work plate 7 in these spaces.

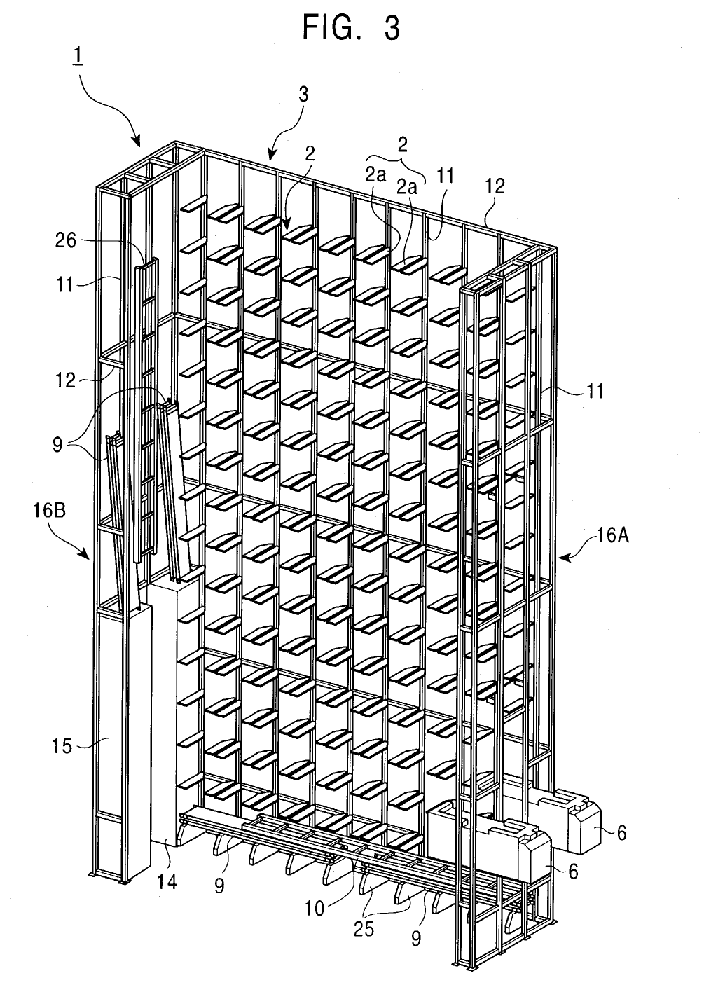

A first housing space is located in the lower part of the rack 3 opposite to the masts 13 as shown in FIGS. 1 and 3. To transfer the cassette 5 between the transfer means 24, provided in the transfer device 4, and the shelf 2, a space must be provided below the lowermost shelf 2 so as to move the elevating and lowering tables 21, 21, the running rail 22, and others through this space. In particular, in retrieving the cassette 5 from the shelf 2, the transfer means 24 must be elevated from below the shelf 2. Accordingly, a space must be provided below the shelf 2 so as to lower the transfer means 24 into this space. That is, the lowermost shelf 2 must be disposed above the lowest position to which the transfer means 24 can be lowered. Consequently, a space in which no shelves 2 are provided is formed below the rack 3. In the rack with the masts 13, the masts 13 extend to below the lowermost shelf 2. Further, driving means (not shown in the drawings) or the like is arranged at the side of each of the masts 13. On the other hand, in the rack 3 opposite to the masts 13, a dead space is formed below the lowermost shelf 2. In the present embodiment, this dead space is used to house the constituent members of the work plate 7 (first housing space).

The constituent members (support members 8, 18 and plate materials 9) of the first-level work plate 7 are housed in the first housing space. A plurality of supports 25, 25, . . . are provided on the floor of the automatic warehouse 1 along the extended direction of the rack 3. Articles can be placed on the supports 25, 25, . . . As shown in FIGS. 1 and 3, after the constituent members of the work plate 7 have been housed, the plate materials 9, the support members 8, 18 (not shown in the drawings), the ladder 10 (described later), and others are placed on the supports 25, 25, . . . These members are housed outside the route for the transfer device 4.

A second housing space is located above the cases 14, 15 as shown in FIGS. 1, 2, 3, 4 and other figures. No shelves 2, 2, . . . are arranged above the cases 14, 15 but a dead space is formed in this place. In the present embodiment, this dead space is used to house the constituent members of the work plate 7 (second housing space).

The constituent members (support members 8, 18 and plate materials 9) of the second-level work plate 7 are housed in the second housing space. As shown in FIGS. 1, 3 and 4, the plate materials 9 and the support members 8, 18 (not shown in these drawings) are leaned against the side wall 16A of the automatic warehouse 1 which is closer to the conveyors 6, 6. The plate materials 9 and the support members 8, 18 are also fixed to the side wall 16A using fixtures or the like and are thus housed outside the route for the transfer device 4.

In the present embodiment, the lower part of the rack opposite to the masts 13 is used as the first housing space, while the space above the cases 14, 15 is used as the second housing space. The constituent members of the first- and second-level work plates 7 can be housed in the first and second housing spaces, respectively.

Thus, the constituent members of the work plate 7 are housed in the automatic warehouse 1. This eliminates the need to provide a separate housing space outside the automatic warehouse 1. It is thus possible to promptly install the work plate 7 for maintenance or the like. In this regard, the arrangement for housing the constituent members of the work plate 7 is not limited the one of the present embodiment. The above described effects can be produced provided that the space that houses the constituent members of the work plate 7 is located inside the automatic warehouse and outside the route for the transfer device.

With reference to FIGS. 3, 4, 5, 6, 7 and 8, a description will be given of a procedure of installing the work plate 7.

First, the support members 8, 18, used to constitute the first-level work plate 7, are taken out from the first housing space (located in the lower part of the rack opposite to the masts 13), shown in FIG. 3. The support members 8, 18 are attached to the corresponding body materials so as to bridge across the racks 3, 3 as shown in FIG. 4. In FIG. 4, the rack 3 opposite to the masts 13 has been removed to expose the rack 3 with the masts 13. Thus, FIG. 4 only shows how the support members 8, 18 are attached to the body material with the masts 13. A description will be given later of an arrangement for attaching and removing the support members 8, 18 to and from the corresponding body materials.

As shown in FIGS. 4, 5, 6 and other figures, the support members 8, 18 are attached to the corresponding body materials at positions at which brackets 17 are provided, i.e. predetermined positions described later. The brackets 17 will be described later in detail. In the present embodiment, the work plate 7 is formed every five shelves 2. Accordingly, the support members 8, 18 are attached every five shelves 2 in the vertical direction. This height is such that an operator exceeding the average height does not contact with the bottom surface of the work plate 7 or the ceiling surface of the automatic warehouse 1 when walking on the floor surface or work plate 7 of the automatic warehouse 1.

The support member 28 is also fixed at the same height as the support members 8, 18. Each of the plate materials 9 is formed to be about four times as laterally long as the shelf 2 in the direction in which it is extended. The support member 28 is fixed to the corresponding body material at a position closer to the conveyors 6, 6 than to the masts 3. The support member 8 is detachably installed on the mast 13 and the strut 11 located opposite the mast 13. The support member 18 is detachably provided halfway between the support members 8, 28. The interval between the support members 8, 18 and the interval between the support members 18, 28 are each equal to the length of the plate material 9 in its extended direction. It is thus possible to attach the plate materials 9 of the same configuration between the support members 8, 18 and between the support members 18, 28.

Now, as shown in FIG. 5, the plate materials 9 are attached so as to extend between the support members 8, 18 and between the support members 18, 28.

The two plate materials 9 are installed between the support members. The three support members 8, 18 and 28 and the four plate materials 9 thus form the one work plate 7. A description will be given below of an arrangement for attaching the plate materials 9 to the support members 8, 18 and 28. In this regard, the work plate 7 is formed between the mast 13 and the cases 14, 15. Accordingly, in a plan view, an opening is formed between the work plate 7 and a side wall 16B of the automatic warehouse 1 which is closer to the cases 14, 15 so that the operator can pass through this space. The operator can climb up and down ladders 10, 26 through this space.

Once the first-level work plate 7 is formed as described above, the second-level work plate 8 starts to be formed. Not only the support members 8, 18 and plate materials 9 but also the ladder 10 are housed in the first housing space. The ladder 10 is arranged between the cases 14, 15 so as to lean against the side wall 16B of the automatic warehouse 1 which is closer to the cases 14, 15. The ladder 26 is fixed to the inside of the side wall 16B above the cases 14, 15. The ladders 10, 26 are means for allowing the operator to climb onto the first-level work plate 7 and second-level work plate 7. A shaft portion is provided at the lower end of the ladder 26. On the other hand, a hook portion is provided at one end of the ladder 10 in its extended direction so that the shaft portion can be inserted into the hook portion. To lean the ladder 10 against the side wall 16B, the ladder 10 is fixed by being arranged so that the hook portion is located at its upper end and then inserting the shaft portion into the hook portion.

When it becomes possible for the operator to climb onto the first-level work plate 7, the second-level work plate 7 starts to be formed. First, the support members 8, 18 are taken out of the second housing space. The support members 8, 18 are attached to the corresponding body materials immediately above the support members 8, 18, which constitute the first-level work plate 7, so that the support members 8, 18 bridge across the racks 3, 3. Further, the support member 28, which constitutes the second-level work plate 7, is provided immediately above the first-level work plate 7. That is, the first- and second-level work plates 7 are disposed at the same position in the lateral direction of the support members 8, 18 and 28. The second-level work plate 7 is provided immediately above the first-level work plate 7.

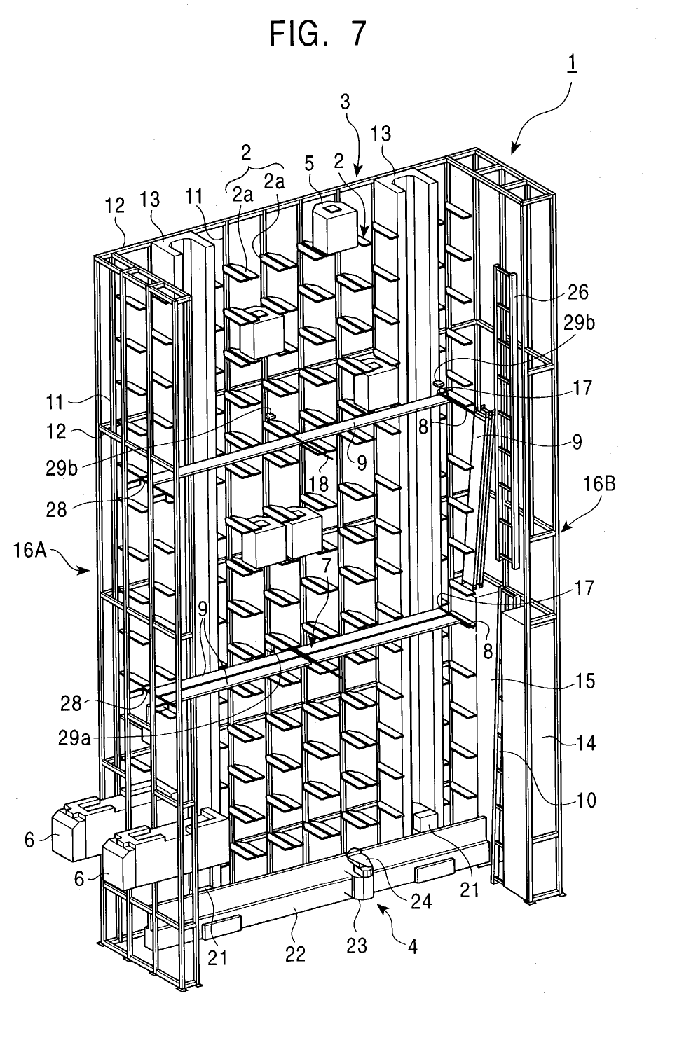

Then, as shown in FIG. 7, the plate materials 9 are attached so as to extend between the support members 8, 18 and between the support members 18, 28. The two plate materials 9 are inserted between the support members. The three support members 8, 18 and 28 and the four plate materials 9 thus form the one work plate 7. In this case, the second-level work plate 7 is located immediately above the first-level work plate 7. Thus, also at the second level, an opening is formed between the work plate 7 and the side wall 16B closer to the cases 14, 15 so that the operator can pass through the opening. Then, the operator can climb up and down the ladder 26 through this opening.

The second-level work plate 7 is formed as described above. The first- and second-level work plates 7, 7 are thus installed in the automatic warehouse 1. After the work plates 7, 7 have been completed and before the operator performs an actual operation, the opening may be closed.

With reference to FIGS. 4, 9, 10, 11 and 12, a description will be given of an arrangement for enabling the support members 8, 18 to be attached to and removed from the body material.

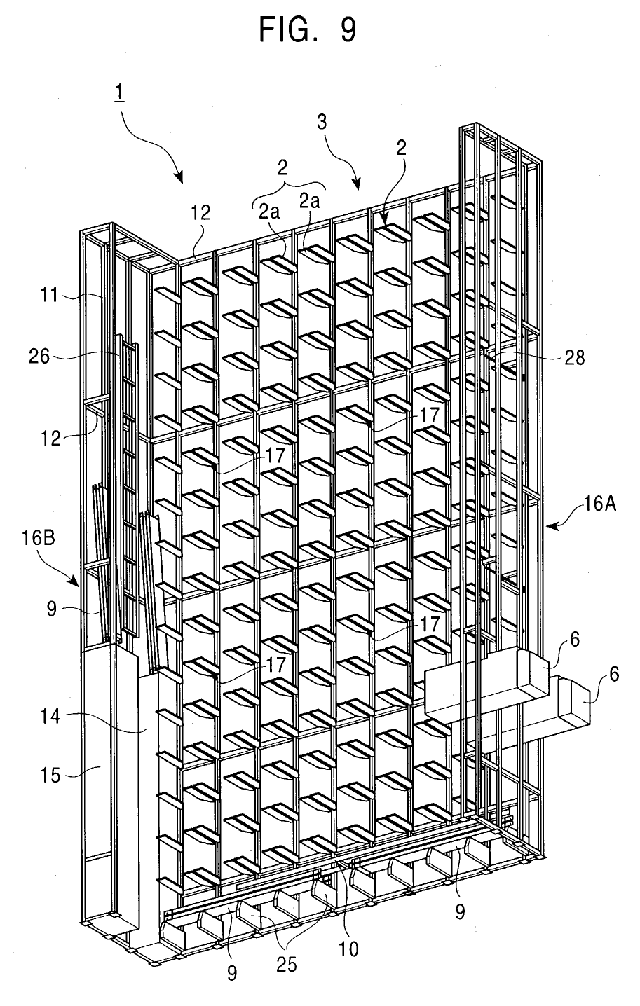

The brackets 17 are fixed to the body material at the same positions at which the support members 8, 18 are attached as shown in FIGS. 4 and 9. The support members 8, 18 and the brackets 17 are configured so as to engage with one another. A specific description will be given below.

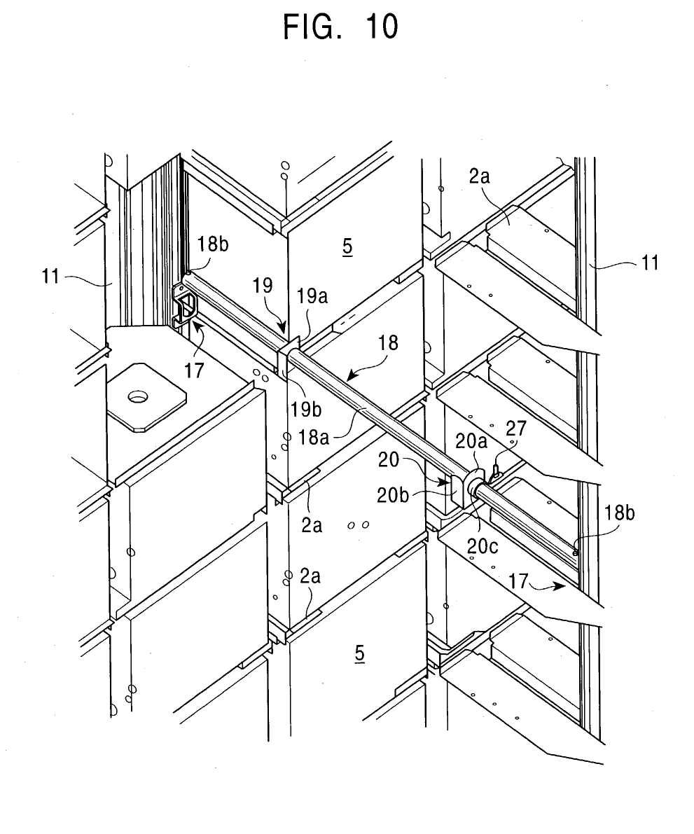

The main bodies of the support members 8, 18 are formed like rods. FIG. 10 shows only the support member 18. In connection with an arrangement for attachment to and removal from the brackets 17, only the support member 18 will be described below because it has a configuration similar to that of the support member 8. Projecting portions are provided at the respective ends of a main body 18a so as to project laterally from the main body 18a. In the present embodiment, the projecting portions are configured as described below. A pair of lock pins 18b, 18b is fixed to the respective ends of the main body 18a at opposite positions. The lock pins 18b, 18b are located on the same axis, with their axes perpendicular to the main body 18a. The lock pins 18b, 18b constitute the projecting portions projecting laterally from the main body 18a.

The main body 18a is formed like a cylinder and has a circular cross section. Even when the support member 18 is rotated around the axis of the main body 18a, the lateral length of the main body 18a remains unchanged. The lock pins 18b, 18b constitute the projecting portions at the respective ends of the main body 18a. A cross section of end of the support member 18 is longer in the axial direction of the lock pins 18b, 18b and shorter in the other direction. That is, the cross section has the lock pins 18b, 18b in its longitudinal direction and does not have the lock pins 18b, 18b in its latitudinal direction. Accordingly, when the support member 18 is rotated around its own axis, the lateral length of end of the support member 18 does not remain unchanged and varies depending on a rotation angle.

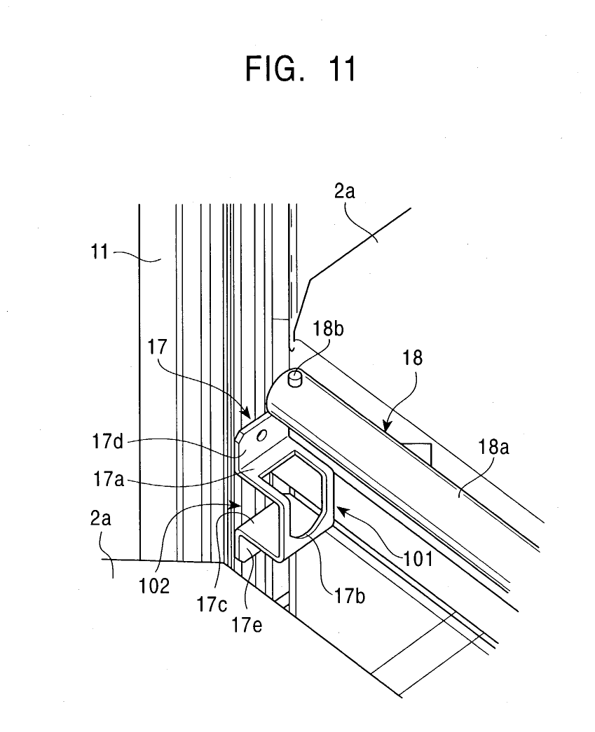

On the other hand, the brackets 17, which detachably support the support member 18, are configured as described below. As shown in FIG. 11, each of the brackets 17 is formed like the character U so as to contain a space in a side view. The bracket 17 is fixed so that its opening faces the strut 11 (body material side). The lock pin 18b can be positioned above the bracket 17, aligned with the space in the horizontal direction, and then inserted into it. The space is in communication with the opening (described later in detail), formed so that the lock pin 18b can be aligned with it in the vertical direction and then inserted into it. Then, the lock pin 18 and the bracket 17 are engaged with each other by inserting the support member 18 with the lock pin 18b into the space from above the opening so that the lock pin 18b aligns with the space in the vertical direction and then rotating the support member 18 around its axis while being supported by the bracket 17. The bracket 17 will be described below in detail. The bracket 17 comprises an upper plate portion 17a and a lower plate portion 17c which are parallel with each other, and a side plate portion 17b that bridges across the upper plate portion 17a and the lower plate portion on a side of the bracket 17 which is not fixed to the strut 11. These plate portions form the character U. With these arrangements, the bracket 17 is open in the lateral direction. Extending portions 17d, 17e are formed on the upper plate portion 17a and the lower plate portion 17c, respectively, so as to extend outward from that end of the bracket which is opposite the side plate portion 17b. A hole is formed in each of the extending portions 17d, 17e so that a bolt can be tightened into the hole. The bracket 17 is fixed to the strut 11 by tightening the bolts.

The opening is formed in the upper part of the bracket 17. The bracket 17 is concave because the opening is formed so as to extend from the side plate portion 17b toward the extending portion 17d. The side plate portion 17b is also concave because the opening is formed so as to extend from the upper plate portion 17a toward the lower plate portion 17c. Then, the opening formed in the upper plate portion 17a and side plate portion 17b forms the opening of the bracket 17.

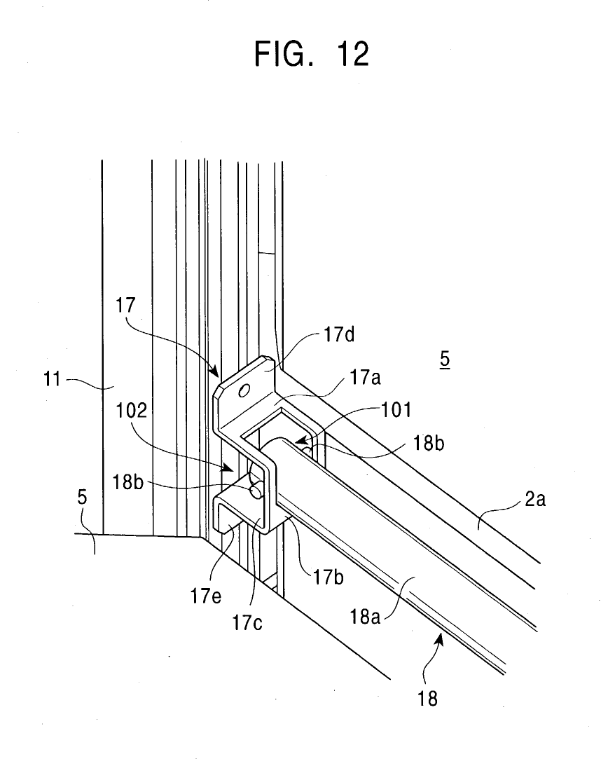

The opening of the bracket 17 is composed of a first opening 101 formed in the upper plate portion 17a and side plate portion 17b and a second opening 102 formed inside the upper plate portion 17a and side plate portion 17b (inside the bracket 17) as shown in FIGS. 11 and 12. The bracket 17 is open in the lateral direction. Thus, in the present embodiment, the second opening 102 is substantially a space. The vertical lengths of the side plate portion 17b and the opening formed in the side plate portion 17b are each larger than the outer diameter of the main body 18a. The main body 18a can thus be inserted below the upper plate portion 17a as shown in FIG. 12. That is, the depth of opening or the bracket 17 is such that the main body 18a can be inserted into the opening. The lateral length of the first opening 101, formed in the upper plate portion 17a and the side plate portion 17b, is equal to the outer diameter of the main body 18a, that is, to the latitudinal length of end of the support member 18. Further, the second opening 102, located inside the upper plate portion 17a and the side plate portion 17b, is a simple space and thus has a lateral length equal to or larger than the longitudinal length of end of the support member 18.

With these arrangements, the support member 18 can be inserted into the opening of the bracket 17 so that the latitudinal length of end of the support member 18 extends in the lateral direction. That is, the support member 18 is rotated before insertion so that the axial direction of the lock pins 18b, 18b equals the vertical direction. The position established after the rotation corresponds to an unengaged position of the support portion 18. Once the support member 18 is inserted into the bracket 17, the concave side plate portion 17b, which has the opening in its upper part, acts to position the end of the support member 18 in the lateral direction. The opening formed in the side plate portion 17b is a part of the first opening 101. The lateral length of the opening in the side plate portion 17b equals the outer diameter of the main body 18a (the latitudinal length of the support member 18). Consequently, after the support member 18 has been inserted into the bracket 17, the opening formed in the side plate portion 17b inhibits the lateral movement of the support member 18.

The opening formed in the side plate portion 17b is formed by combining a semicircular lower portion with a rectangular upper portion. Thus, after the support member 18 has been inserted into the bracket 17 (unengaged position), the support member 18 with the cylindrical main body 18a can be rotated around its own axis. Upon insertion (shown in FIG. 11), as previously described, the support member 18 is in its non-engaged position and the latitudinal length of end of the support member 18 corresponds to the lateral direction. After insertion, when the support member 18 is rotated through 90 degrees around its own axis, the longitudinal direction of end of the support member 18 corresponds to the lateral direction. That is, the support member 18 is rotated so that the axial direction of the lock pins 18b, 18b is switched from the vertical direction, corresponding to the unengaged position, to the lateral direction. The position established after the rotation corresponds to an engaged position of the support member 18. At the engaged position, the support member 18 and the bracket 17 are engaged with each other. Specifically, the lock pins 18b, 18b, the projecting portions formed on the support member 18, regulate the vertical and front-to-back (the direction in which the racks 3, 3 are arranged parallel with each other) movement of the support member 18. In the vertical direction, the lateral length of the opening formed in the upper plate portion 17a equals the previously described latitudinal length. Accordingly, the upper plate portion 17a regulates the vertical movement of the support member. Further, in the front-to-back direction, the lateral length of the opening formed in the side plate portion 17b equals the previously described latitudinal length. Accordingly, the side plate portion 17b regulates the vertical movement of the support member. The openings formed in the upper plate portion 17a and the side plate portion 17b each constitute a part of the first opening 101.

Comprehensive description will be given of the arrangement for engaging the support member 18 and the bracket 17 together. The main body 18a of the support member 18 is formed like a rod. The projecting portions (lock pins 18b, 18b) are provided at the respective ends of the main body 18a so as to extend laterally from the main body 18a. The cross section of end of the main body 18a is longer in its side with the projecting portions (lock pins 18b, 18b) and is shorter in its side without any projecting portions. On the other hand, the opening is formed in the upper part of the bracket 17. The depth of the opening is such that the main body 18a can be inserted into the opening. Specifically, the vertical lengths of the side plate portion 17b and the opening formed in the side plate portion 17b are each larger than the outer diameter of the main body 18a. Further, the opening of the bracket 17 comprises the first opening 101, formed in the upper plate portion 17a and side plate portion 17b, and the second opening 102, formed inside the upper plate portion 17a and side plate portion 17b. The first opening 101 is located above the second opening 102 and on a side of the bracket 17 which is opposite its side fixed to the corresponding body material. Further, the lateral length of opening of the first opening 101 equals the latitudinal length of end of the support member 18. The lateral length of opening of the second opening 102 is larger than the longitudinal length of end of the support member 18.

With these arrangements, the support member 18, in its unengaged position (the position in which the projecting portions extend in the vertical direction) can be freely attached to and removed from the bracket 17 installed on the corresponding body material. In this state, the support member 18 is inhibited from moving laterally with respect to the body (bracket 17) of the automatic warehouse 1. Further, when switched from its unengaged position to its engaged position (the position in which the projecting portions extend in the lateral direction), the bracket 18 is engaged with the bracket 17 and thus inhibited from moving in the lateral direction as previously described as well as moving back and forth and in the vertical direction. The bracket 17 is thus prevented from slipping out of the support member 18. That is, the support member 18 can be attached to and removed from the bracket 17 by configuring the support member 18 and the bracket 17 so as to provide the support member 18 with its engaged and unengaged positions.

Thus, the support member 18 can be easily attached to and removed from the bracket 17. Further, it is possible to easily construct the arrangement for engaging the support member 18 and the bracket 17 together. This enables easy configuration of a support member that can be attached to and removed from the corresponding body material. Therefore, the costs of the automatic warehouse 1 provided with the work plates 7 can be reduced. Further, the structure of the automatic warehouse is simplified to improve its durability.

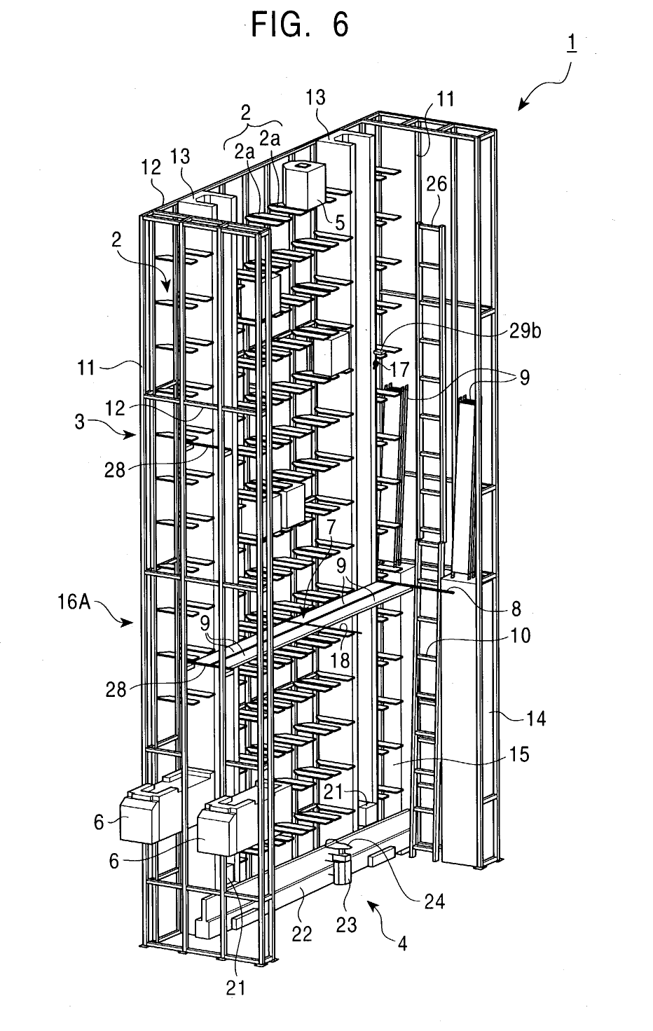

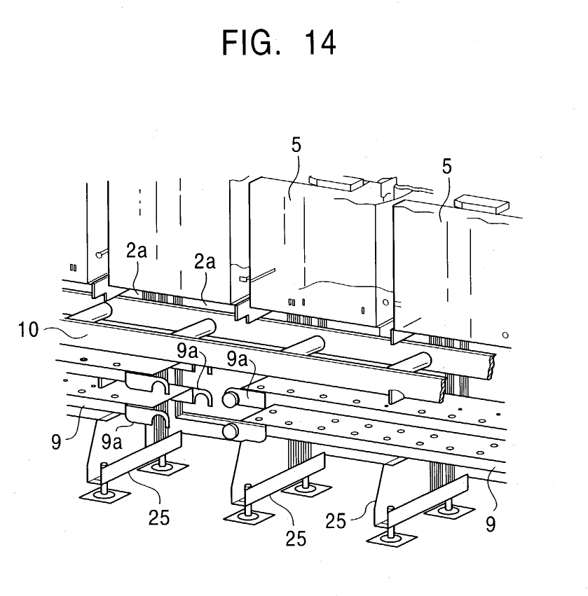

Now, with reference to FIGS. 6, 8, 10, 13, 14 and 15, a description will be given of a configuration of means for fixing the plate materials 9 installed on the support members 18.

Compared to the support members 8, 18, the support member 18 is provided with fixing means for preventing the plate materials 9 from floating from the support member 18. In the present embodiment, the support member 18 supports the four plate materials 9, constituting the one work plate 7, as shown in FIGS. 6, 8 and 13. Accordingly, the plate materials 9 can be fixed by providing the support member 18 with the means for fixing the plate materials 9.

Hook portions 9a, 9a are provided at the respective ends of the plate material 9 in its extended direction (longitudinal direction) so that the main body 18a of the support member 18 can be inserted into the hook portions 9a, 9a.

Accordingly, the four hook portions 9a are provided on the one plate material 9. In this case, the hook portions 9a are engaging sections that engage the plate materials 9 with the support member 18. Then, the plate materials 9 are attached to the support members 8, 18 and others by arranging the plate materials 9 between the support members 8, 18 or between the support members 18, 28.

As shown in FIG. 10, a pair of locking means for locking the plate materials 9 is provided on the main body 18a of the support member 18 as means for locking the plate materials 9. The locking means is composed of a locking member 19 fixed to the main body 18a and a locking member 20 that can be moved with respect to the main body 18a. After the plate materials 9 have been attached to the main body 18a, the locking members 19, 20 hinder the hook portions 9a, locking sections, from moving in the vertical direction or back and forth. This prevents the plate materials 9 from slipping out or being misaligned. A specific description will be given later.

First, the locking member 19 will be described with reference to FIG. 10. The locking member 19 comprises a front-to-back movement locking section 19a perpendicular to the main body 18a and a vertical movement locking section 19b that extends from and end of the front-to-back movement locking section 19a in the axial direction of the main body 18a. The main body 18a is inserted through a central portion of the front-to-back movement locking section 19a. The front-to-back movement locking section 19a is fixed to the main body 18a by, for example, welding.

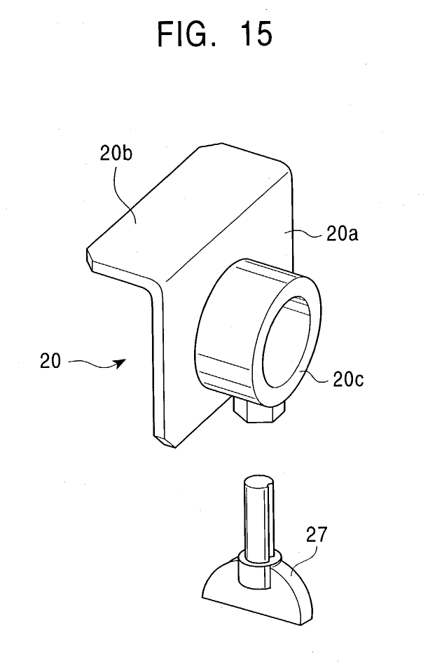

The locking member 20 will be described with reference to FIG. 15. The locking member 20 comprises a front-to-back movement locking section 20a perpendicular to the main body 18a and a vertical movement locking section 20b that extends from and end of the front-to-back movement locking section 20a in the axial direction of the main body 18a. A hole is formed in a central portion of the front-to-back movement locking section 20a so that the main body 18a can be inserted through the hole. Further, a cylindrical portion 20c is fixed to the front-to-back movement locking section 20a. The cylindrical portion 20c is installed in communication with the through-hole formed in the front-to-back movement locking section 20a. Then, the main body 18a is inserted through the locking member 20 so as to allow the locking member 20 to move along the main body 18a. Further, a bolt hole is formed in a side of the cylindrical portion 20c so as to extend from outer periphery to internal hollow portion of the cylindrical portion 20c. The locking member 20 can be fixed to the main body 18a at its arbitrary position by inserting a bolt 27 through the bolt hole and abutting the tip of the bolt 27 against the main body 18a located inside the cylindrical portion 20c.

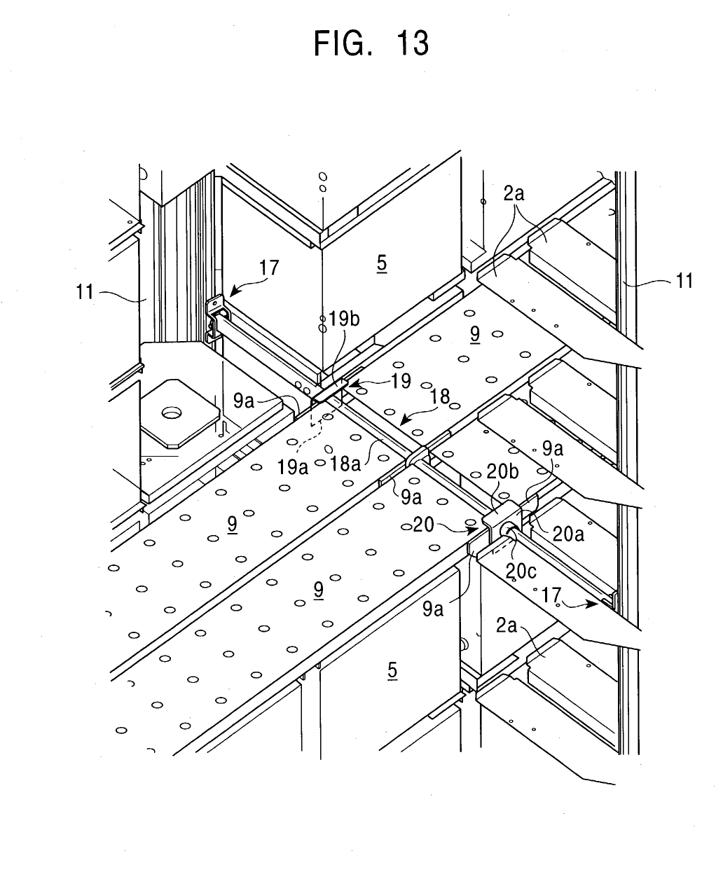

After the work plate 7 has been formed, the plate materials 9, 9, . . . are located between the racks 3, 3. If any plate material 9 shifts toward the rack 3, the plate material 9 interferes with the shelves 2 to cause inconvenience. To prevent this inconvenience, the locking members 19, 20 are used to hinder the plate materials 9, 9, . . . from moving back and forth. As shown in FIG. 13, the plate materials 9, 9 are sandwiched between the pair of locking members 19, 20 in the front-to-back direction and are thus located between the racks 3, 3. The locking member 19 is fixed to the main body 18a. Accordingly, the locking member 19 is fixed at the same position at which the support member 18 is attached to the bracket 17 to constitute an end of the rack 3. If the support member 18 is arranged as shown in FIG. 13, i.e., if the support member 18 is arranged so that the locking member 19 is located closer to the masts 13, while the locking member 20 is located opposite the masts 13, the locking member 13 is located at the front end of the rack with the masts 13. On the other hand, the locking member 20 can be moved along the main body 18a. To attach the plate material 9 to the support material 18, the locking member 20 is first moved toward the center between the racks 3, 3 with the hook portion 9a of the plate material 9 inserted over the main body 18a. Then, the front-to-back movement locking section 20a of the locking member 20 is abutted against the hook portion 9a of the plate material 9 and then fixed using the bolt 27. At this time, the locking member 20 is located at the end of the rack 3. If the support member 18 is arranged as shown in FIG. 13, the locking member 20 is located at the rear end of the rack opposite to the masts 13.

Once each locking member 20 has been completely fixed, the plate materials 9, 9, . . . are sandwiched between the front-to-back movement locking sections 19a, 20a of the locking members 19, 20, respectively, in the front-to-back direction as shown in FIG. 13. The cylindrical portion 20c, formed in the locking member 20, provided on the shaft of the main body 18a and opposite the locking member 19.

Each of the vertical movement locking sections 19b, 20b, provided in the locking members 19, 20, respectively, extends toward the opposite locking member. The vertical movement locking section 19b is provided parallel with the axial direction of the locking pins 18b, 18b, the projecting portions. When the support member 18 is in its engaged position, the vertical movement locking section 19b is located above the main body 18a. Accordingly, when the support member 18 is in its engaged position, the vertical movement locking sections 19b, 20b can both be located above the main body 18a. Then, after the previously described fixation of the locking member 20 has been completed, the vertical movement locking sections 19a, 20a are located above the hook portions 9a, 9a, . . . and above a part of top surface of each of the plate materials 9, 9, . . . located inside the locking members 19, 20. This prevents the plate materials 9 from floating from the support member 18.

Comprehensive description will be given of the means for fixing the plate materials 9 installed on the support member 18. The engaging section (hook portion 9a) is provided at the longitudinal end of the plate material 9 so that the main body 18a of the support member 18 can be inserted into the engaging section. The plate material 9 can thus be attached to the main body 18a. Further, the locking members 19, 20 are provided on the main body 18a to lock the plate materials 9. The locking sections (vertical movement locking sections 19a, 20a) are provided in the locking members 19, 20 to regulate the upward movement of the plate materials 9. Further, one 20 of the locking members 19, 20 can be moved along the main body 18a.

Thus, the simple arrangements can be used to prevent the plate materials 9 from slipping out of the support member 18. Further, the plate materials 9, 9, . . . regulates the rotation of the support member 18 with respect to the plate materials 9, 9, . . . Thus, if the rotation of the support member 18 around its own shaft is utilized (the previously described engaged position and unengaged position) as the arrangement for attaching and removing the support member 18 to and from the body member, the plate materials 9 are fixed to reinforce the fixation of the support member 18 to the body member. This allows the work plate 7 to be more stably installed.

Comprehensive description will be given of the configuration of the support member 18. As described above, the body member is provided with the brackets 17. Each of the brackets 17 and the corresponding support member 18 can be engaged with each other. The support member 18 has its engaged position and unengaged position. The support member 18, in its unengaged position, can be freely attached to and removed from the bracket 17. The support member 18, in its engaged position, engages with the bracket 17. Further, the fixing means is provided on the support member 18 to prevent the plate materials 9 from slipping out of the support member 18. The fixing means is composed of the engaging members 19, 20. Furthermore, by fixing the plate materials 9 to the support member 18 using the fixing means, the support member 18 can be prevented from rotating from its engaged position to its unengaged position.

Thus, the position of the support member 18 with respect to the body member can be regulated by engaging the support member 18 with the corresponding bracket 17 provided on the body member. Further, the work plate 7 can be more stably disposed by fixing the plate materials 9 to the support member 18.

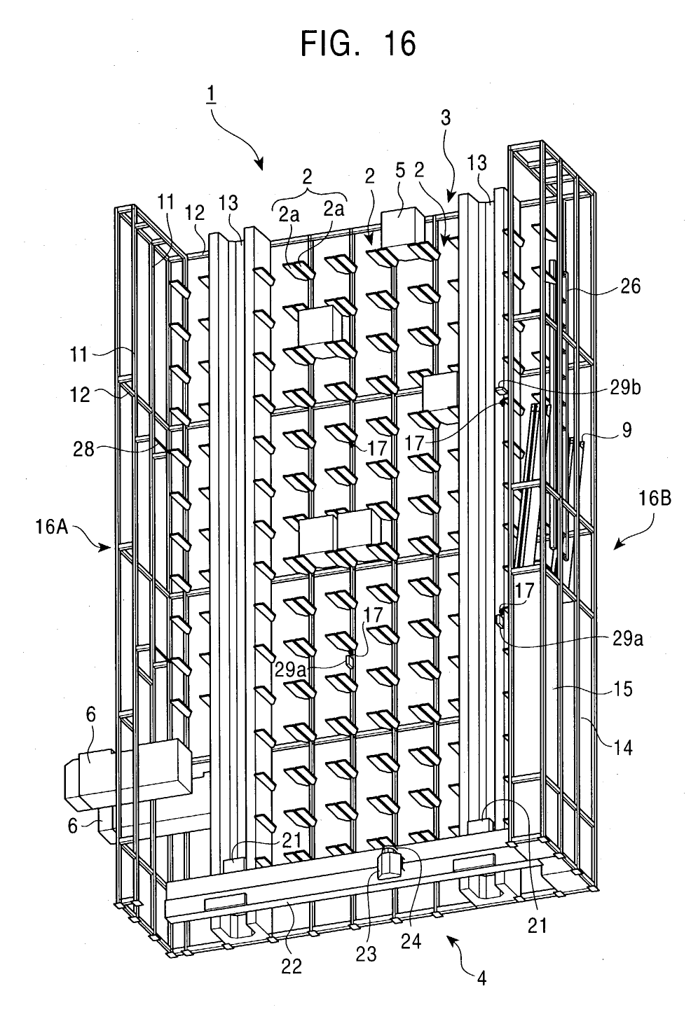

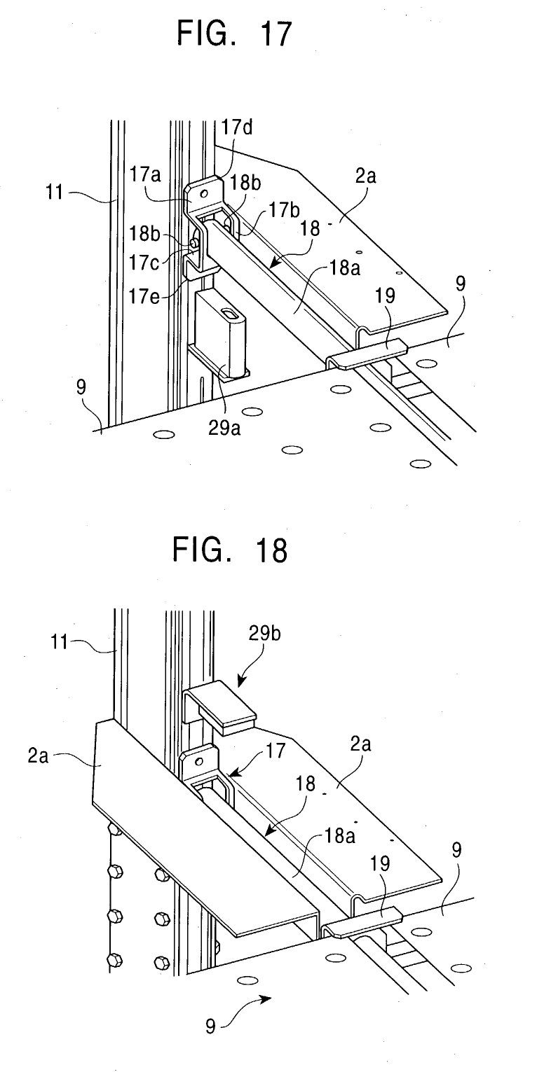

A leave-behind preventing sensor 29 for the support members 8, 18 will be described with reference to FIGS. 4, 16, 17, 18 and 19.

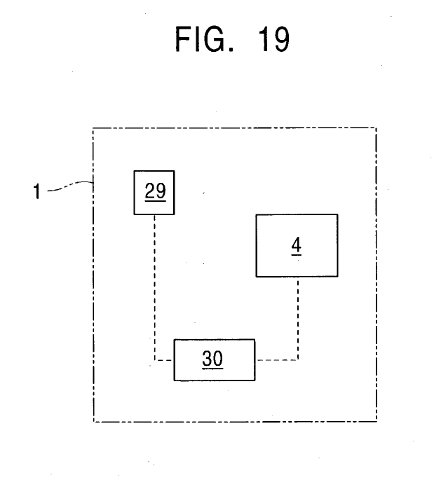

The body materials, to and from which the support members 8, 18 can be attached and removed, are each provided with the leave-behind preventing sensor 29 (shown in FIG. 19) that detects the presence of the support member 18 on the body material. The leave-behind preventing sensor 29 is an optical sensor composed of the light emitting section 29a and the light receiving section 29b.

As shown in FIGS. 4, 16, 17 and 18, the light emitting section 29a and the light receiving section 29b are provided in the lower and upper parts, respectively, of each of the mast 13 and strut 11, on which each of the support members 8, 18 is installed. In the present embodiment, the light emitting section 29a is located in the lower part, whereas the light receiving section 29b is located in the upper part. When the support members 8, 18 are arranged on the corresponding body materials, a light passage from the light emitting section 29a to the light receiving section 29b is interrupted. Thus, the leave-behind sensor 29 detects the presence of the support member.

One pair of support members 8, 18 is used for each level at which the work plate 7 is provided. Accordingly, two pairs of support members 8, 18 are arranged in the automatic warehouse 1 as a whole when the work plates 7 are arranged. On the other hand, the leave-behind preventing sensor 29 is provided for each body material on which the support member 8, 18. Accordingly, two leave-behind preventing sensors 29 are provided in the automatic warehouse 1 as a whole. In the present embodiment, the support members 8, 18 and 28 are located at the same lateral positions for the first- and second-level work plates 7. Consequently, the single leave-behind preventing sensor 29 can detect the presence of the two support members installed on the same body material.

The leave-behind preventing sensor 29 detects the support members 8, 18 after the work plates 7 have been dismantled and before the automatic warehouse 1 starts to be operated. This detection is carried out in order to check whether any of the support members 8, 18 is left behind on the corresponding body material or all support members have been housed. Accordingly, it is unnecessary to detect the number of support members 8, 18 left on the corresponding body materials, and the above arrangement is sufficient. Further, if all support members 8, 18 have been housed and the leave-behind sensor 29 does not detect the support members 8, 18, it is expected that all constituent members of the work plate 7, including the plate materials 9, have been removed from the route for the transfer device 4.

A control mechanism is provided in the automatic warehouse 1 to prevent the support members 8, 18 from being left behind. As shown in FIG. 19, control means 30 is provided in the automatic warehouse 1 to detect the presence of the support members 8, 18 on the corresponding body material and regulate operations of the transfer device 4, on the basis of a detection signal from the leave-behind preventing sensor 29. The control means 30 is connected to the leave-behind preventing sensor 29 and transfer device 4 so as to transmit signals to them. The control means 30 is provided in one of the cases 14, 15.

The control means 30 provides such control as prevents the transfer device 4 from operating while the leave-behind protecting sensor 29 remains detecting the support members 8, 18 on the corresponding body material. These arrangements constitute the control mechanism for preventing the support members 8, 18 from being left behind.

Thus, while the leave-behind preventing sensor 29 remains detecting the support member 8, 18 on the corresponding body material, the transfer device 4 is not actuated. This prevents the transfer device 4 from coming into contact with any constituent member of the work plate 7 which the operator has forgotten to remove.

Further, the configuration of the transfer device provided in the automatic warehouse 1 is not limited to the present embodiment. In the present embodiment, the pair of masts is provided on the body material side of the automatic warehouse 1. Further, the running rail and the transfer means, which runs along the running rail, are provided on the elevating and lowering tables, which elevate and lower along the corresponding masts. In place of the configuration of the present embodiment, the transfer means may be provided with a carriage that runs along a rail laid between the pair of racks 3, 3. Further, a mast may be provided on the carrier, and transfer means may be provided which elevates and lowers along the mast. In this case, the body materials to which the support members are attached do not include both mast 13 and strut 11 as in the present embodiment, but are composed only of the strut 11. Of course, the support member can be provided between the connection materials 12, 12, previously described.

Furthermore, in the automatic warehouse 1 in the present embodiment, the work plates 7 are laid between the pair of racks 3, 3. However, for example, only one rack 3 may be provided, and the work plates may be laid between the rack 3 and the opposite wall (body material) via the transfer device 4.

According to claim 1, there is provided an automatic warehouse comprising a housing section provided with a large number of shelves arranged at least in a vertical direction and a transfer device that moves along the housing section, wherein work plates are provided to block a route for the transfer device so as to form levels.

Consequently, the operator can safely perform a maintenance operation or the like even in an area located above his or her height as required. Further, the work plates can be used not only for maintenance but also for construction.

As set forth in claim 2, each of the work plates comprises support members and plate materials that can be freely attached to and removed from the support members, and brackets are provided on corresponding body materials constituting a frame of the automatic warehouse so that the support members can be freely attached to and removed from the corresponding brackets.

Consequently, the work plates can be easily attached and removed.

As set forth in claim 3, the constituent members of each work plate are housed inside the automatic warehouse and outside the route for the transfer device. The constituent members of the work plate are housed inside the automatic warehouse, eliminating the need to provide a separate housing space outside the automatic warehouse.

Therefore, the work plates can be promptly installed for maintenance or the like.

As set forth in claim 4, the support member is provided on each of the support members to prevent the plate materials from rising from the support members.

Consequently, the plate materials can be easily prevented from floating from the support members.

As set forth in claim 5, a sensor is provided to detect the presence of the work plate, and control means is provided to regulate operations of the transfer device while the sensor remains detecting the work plate.

Consequently, while the sensor remains detecting the work plate, the transfer device is not actuated. This prevents the transfer device from coming into contact with any work plate which the operator has forgotten to remove.

1. An automatic warehouse comprising a housing section provided with a large number of shelves arranged at least in a vertical direction and a transfer device that moves along the housing section, the automatic warehouse being characterized in that work plates are provided to block a route for the transfer device so as to form levels.

2. An automatic warehouse according to claim 1, characterized in that each of said work plates comprises support members and plate materials that can be freely attached to and removed from the support members, and brackets are provided on corresponding body materials constituting a frame of the automatic warehouse so that the support members can be freely attached to and removed from the corresponding brackets.

3. An automatic warehouse according to claim 1, characterized in that a space is provided inside the automatic warehouse and outside the route for said transfer device.

4. An automatic warehouse according to claim 2, characterized in that said support member is provided on each of said support members to prevent said plate materials from rising from the support members.

5. An automatic warehouse according to claim 1, characterized in that a sensor is provided to detect the presence of the work plate, and control means is provided to regulate operations of the transfer device while the sensor remains detecting the work plate.
